(19) United States
(12) Patent Application Publication
(10) Pub. No.: US 2026/0098619 A1
(43) Pub. Date: Apr. 9, 2026

(54) A SYSTEM AND METHOD FOR COLLECTING, STORING AND RELEASING ENERGY

(71) Applicant: ATOA SCIENTIFIC TECHNOLOGIES PVT. LTD, BANGALORE (IN)

(72) Inventor: Raj CN THIAGARAJAN, BANGAORE (IN)

(21) Appl. No.: 19/110,591

(22) PCT Filed: Sep. 24, 2022
(86) PCT No.: PCT/IB2022/059057

§ 371 Date: Mar. 11, 2025

(30) Foreign Application Priority Data
Sep. 23, 2022 (IN) 202241054671

(51) Int. Cl. F21S 11/00; F24S 23/00; F24S 23/30; F24S 23/70

(52) U.S. Cl. CPC F21S 11/005; F24S 23/10; F24S 23/31; F24S 23/82; F24S 2023/872; F24S 2023/88

(57) ABSTRACT

The present disclosure provides a system and method for collecting, focusing, storing, and releasing energy. The system comprises of a collector unit (102) provided for collecting energy (101) released from a source (110) using optical means. A storage unit (103) is operatively connected to the collector unit (102) for storing the collected energy using optical means and a reflector unit (104) is operatively connected to the storage unit (103) for reflecting the stored energy released from the storage unit (103) using optical means.

### FIELD

The embodiments herein generally relate to collection, storage and usage of energy. More particularly, the disclosure relates to a system for collecting energy, storing the energy and releasing the energy for usage.

### BACKGROUND AND PRIOR ART

Every available application, apparatus and device is dependent on a source of energy for efficient working. The Sun is one of the renewable sources of energy available on the Earth as a cost-effective, environmental friendly and sustainable option for usage.

However, availability of solar energy from the Sun at a given location on Earth is limited based on the rotation of earth, season, weather conditions, and various other factors. Harvesting of solar energy has to be performed effectively in the available duration, for ensuring sufficient compensation during non-accessibility of the solar energy.

Conventional systems and technologies that harvest various forms of solar energy are capable of converting one form of solar energy into another form suitable, such as, electricity for ease of storage during periods of non-availability of the Sun, particularly at night, at the location. The stored energy is then reconverted into useful form, such as lighting, at a desired point of time. This conventional system of conversion and reconversion of the solar energy for long term storage wastes great amount of energy requires large number resources, heavy equipment, distribution system, thereby amounting to higher cost and non-affordability. Moreover, distribution and usage of various forms of solar energy is hindered due to improper and inefficient system for storage.

Therefore, there is a need for an efficient and cost-effective system to collect, store and release energy for usage. Moreover, there is a need for a system to effectively store energy for maximum usage.

### OBJECTS

Some of the objects of the present disclosure are described herein below:

The main objective of the present disclosure is to provide a system for storing solar energy.

Another objective of the present disclosure is to provide a system for collecting energy, storing energy and releasing energy.

Still another objective of the present disclosure is to provide a cost-effective system for collecting energy, storing energy for a desired duration and releasing energy.

Yet another objective of the present disclosure is to provide a system for storing energy using total internal reflection.

Another objective of the present disclosure is to provide a system for storing energy using Electromagnetic spectrum system

Still another objective of the present disclosure is to provide a system for storing energy using Solar spectrum system

Yet another objective of the present disclosure is to provide a system for storing energy using optical system.

Another objective of the present disclosure is to provide a solar energy collection, storage and on demand delivery system for a direct solar lighting system (DSLS), wherein the system collects solar energy during day time, stores all the daytime solar energy, releases the energy in the night time, directly as light energy for illumination purpose.

Still another objective of the present disclosure is to provide a solar energy collection, storage and on-demand delivery system that collects solar energy during day time, stores all the daytime solar energy, releases the energy in the night time.

Another objective of the present disclosure is to provide a system that collects solar energy in a form of visible light during day time, stores all the daytime solar energy in the form of visible light, releases the solar energy in the form of visible light in the night time.

Yet another objective of the present disclosure is to provide a direct solar energy lighting system for street, road, railway track, airport runway, outdoor lighting/illumination.

Still another objective of the present disclosure is to provide a direct solar energy lighting system for residential and industrial, indoor lighting/illumination.

Another objective of the present disclosure is to provide a direct solar energy lighting system for agricultural industry such as greenhouse lighting/illumination.

Yet another objective of the present disclosure is to provide a direct solar energy lighting system for general lighting and illumination.

Still another objective of the present disclosure is to provide a direct solar energy lighting system with up conversion of UV to Visible and down conversion of IR to visible for increasing visible radiation and luminance.

Yet another objective of the present disclosure is to provide a direct solar energy lighting system for lighting/illumination using direct solar light after sunset.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides a system for collecting, storing and releasing energy.

In accordance with an embodiment, the system for storing energy comprises a collector unit provided for collecting energy released from a source using optical means, a storage unit operatively connected to the collector unit for storing the collected energy using optical means and a reflector unit operatively connected to the storage unit for reflecting the stored energy released from the storage unit using optical means. In an embodiment, the collector acts as the reflector unit for reflecting the energy. Yet another objective of the present disclosure is to provide a system for storing energy using total internal reflection.

In accordance with an embodiment, the collector unit includes a first portion, a second portion and a third portion. The first portion is provided for maximizing collection of the energy, the second portion provided for propagating the collected energy and the third portion provided for focusing the energy at a predetermined angle. The optical means of the first portion is selected from a group consisting of conventional prism, Fresnel prisms, retro reflectors, moth eye optical elements, refractive optical elements, diffractive optical elements, photonic crystals and metamaterial optical elements. The optical means of the third portion including optical means selected from a group consisting of conventional lens, Fresnel lens, conventional prism, Fresnel prisms, refractive optical elements, diffractive optical elements, photonic crystals and metamaterial optical elements. The optical means of the first, the second and the third portions are provided for maximizing performance.

In accordance with an embodiment, the storage unit includes an input portion, a storage portion and an output portion. The input portion receives the focused energy from the third portion of the collector unit at the predetermined angle for directing the focused energy, the storage portion receives the energy from the input portion and stores the energy through total internal reflection and the output portion releases the stored energy to the reflector unit. In an embodiment, the energy is light energy and the source is Sun. In an embodiment, the first portion of the collector unit converts incident light from the solar energy to visible light. In an embodiment, the predetermined angle is an acceptance angle of the storage unit for low loss storage.

In accordance with an embodiment, the reflector unit includes a first portion, a second portion and a third portion. The first portion is provided proximal to the storage unit for receiving the stored energy, the second portion is provided for propagating the received energy and the third portion is provided distal to the storage unit for reflecting the energy.

In accordance with an embodiment, the output portion of the storage unit includes a releasing unit for releasing the stored energy at a desired time and for a desired duration and the releasing unit includes optical means selected from a group consisting of conventional slots, Fresnel slots, refractive optical elements, diffractive optical elements, photonic crystals and metamaterial optical elements.

In accordance with an embodiment, a structural unit is constructed for connecting the collector unit, the storage unit, and the reflector unit.

In accordance with an embodiment, a material of the storage unit is selected from a group consisting of polymer, glass, composites and related materials for withstanding heat generated from the energy. In an embodiment, a shape of the storage unit is selected from a group consisting of sphere, hollow sphere, cylinder, prism and any shape suitable for storing.

In accordance with an embodiment, the collector unit collects energy during availability of the Sun, the storage unit stores the energy and releases the energy to the reflector unit for reflecting the energy during non-availability of the Sun.

In accordance with an embodiment, an apparatus for interacting with energy includes a collector unit for collecting the energy, a storage unit for receiving the collected energy and storing the received energy, a releasing unit for releasing the stored energy; and a reflector unit for reflecting the released energy. In an embodiment, the energy is selected from a group consisting of electromagnetic energy, solar energy, optical energy and visible light energy. The energy is visible light energy operating using direct optical means and releasing optical energy for illumination. The collector unit performs as the reflector unit. The collector unit, storage unit, the releasing unit and the reflector unit are operationally coupled by optical and structural means.

In an embodiment, operational time is a 24 hours day cycle including collection and storage operational time of 12 hours and releasing operational time between 2 hours to 12 hours. In another embodiment, operational time is an annual cycle including collection and storage operational time greater than 12 hours and releasing operational time greater than a range of 2 hours to 12 hours.

In an embodiment, elements of the collector unit, the storage unit, the releasing unit and the reflector unit are selected from a group consisting of ray, refractive, interference, diffractive, photonic, and meta optical elements for maximizing performance.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1a illustrates an isometric view of the system for collecting, storing and reflecting energy, according to an embodiment herein;

FIG. 1b illustrates a front view of the system for collecting, storing and reflecting energy, according to an embodiment herein;

FIG. 2a illustrates an isometric view of the collector of the system, according to an embodiment herein;

FIG. 2b illustrates a sectional view of the collector of the system, according to an embodiment herein;

FIG. 3a, FIG. 3b, FIG. 3c, FIG. 3d and FIG. 3e illustrate an isometric view of the collector unit of the system, according to alternate embodiments herein;

FIG. 4a, FIG. 4b, FIG. 4c and FIG. 4d illustrate a sectional view of the collector of the system, according to alternate embodiments herein;

FIG. 5a illustrates a front view of a storage unit, according to an embodiment herein;

FIG. 5b illustrates a front view of a storage unit, according to another embodiment herein;

FIG. 6 illustrates an input portion of the storage unit of the system, according to an embodiment herein;

FIG. 7 illustrates an output portion of the storage unit of the system, according to an embodiment herein;

FIG. 8 illustrates a reflector unit of the system, according to an embodiment herein;

FIG. 9 illustrates a structural unit of the system, according to an embodiment herein;

FIG. 10a and FIG. 10b illustrates structural unit of the system, according to alternate embodiments herein;

FIG. 11 illustrates a tracking mechanism of the collector unit of the system, according to an embodiment herein;

FIG. 12a illustrates a system providing large scale collection of energy, storage and distribution of the energy, according to an embodiment herein;

FIG. 12b illustrates a single unit of the system 1200a providing large scale collection of energy, storage and distribution of the energy, according to an embodiment herein;

FIG. 13 illustrates a system providing collection, long term storage of energy, and distribution of the energy, according to an embodiment herein;

FIG. 14a and FIG. 14b illustrate a working of the system for collecting, storing and releasing energy, according to an embodiment herein;

FIG. 15a illustrates a three-dimensional view of ray tracing of energy of the system, according to an embodiment herein;

FIG. 15b illustrates a two-dimensional front view of ray tracing of energy of the system, according to an embodiment herein; and

FIG. 15c illustrates a two-dimensional view of ray tracing of energy inside the storage unit, according to an embodiment herein.

### LIST OF NUMERALS

101—Energy
102—Collector unit
103—Storage unit
104—Reflector unit
105—Structural unit
110—Source of energy
201—First portion
202—Second portion
203—Third portion
501a—Three-dimensional view of Storage unit
501b—Two-dimensional view of Storage unit
502—Input portion
504—Storage portion
506—Output portion
601—Optical means
701—Optical means
801—First portion of reflector unit
802—Second portion of reflector unit
803—Third portion of reflector unit
901—Foundation
902—Structural members
1101—Tracking mechanism
1201—Distribution system
1301—Extended storage portion

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

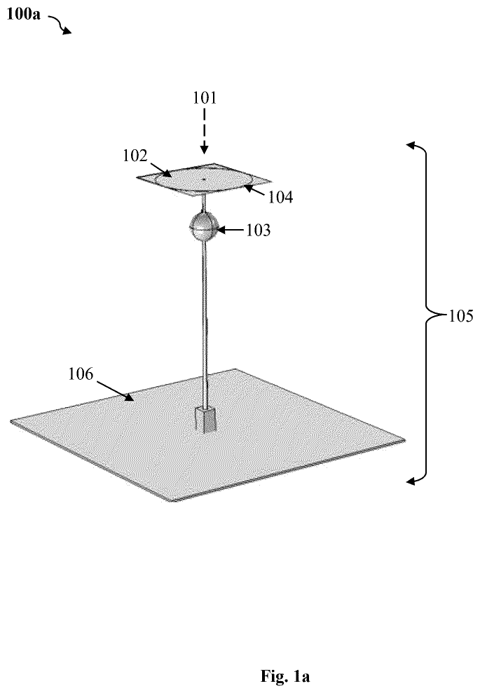

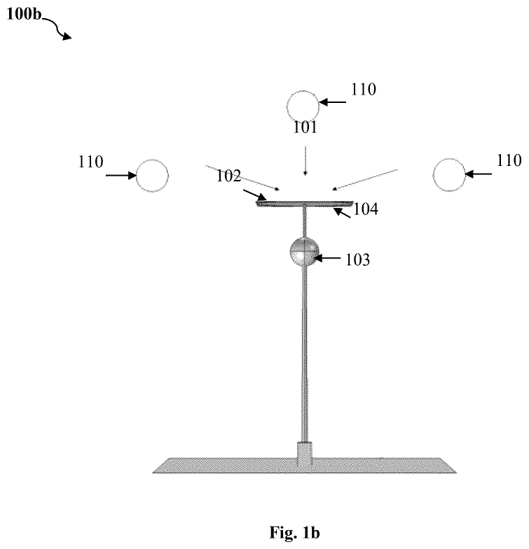

As mentioned above, there is a need for an efficient and cost-effective system to collect, store and release energy for usage. In particular, there is a need for a system to effectively store energy for maximum usage. The embodiments herein achieve this by providing “A system for collecting, storing and releasing energy”. Referring now to the drawings, and more particularly to FIG. 1a through FIG. 15c, where similar reference characters denote corresponding features consistently throughout the figures, there are shown preferred embodiments.

FIG. 1a illustrates an isometric view of the system for collecting, storing and reflecting energy. The system includes collector unit 102, a storage unit 103, a reflector unit 104 and a structural unit 105.

The collector unit 102 is provided for collecting energy 101 from a source. The collector unit 102 includes a plurality of optical means for maximizing collection of the energy 101 from the source and focusing the energy 101 towards a desired direction. In an embodiment, a tracking mechanism is connected to the collector unit 102 for controlling an orientation of the collector unit based on alignment of the optical means of the collector unit 102 relative to the source of energy for maximum harvesting of the energy 101.

The storage unit 103 is operatively connected to the collector unit 102 for storing the collected energy from the collector unit 102. In an embodiment, the storage unit 103 includes a plurality of optical means for storing the energy for a desired duration of time. In an embodiment, the energy 101 is stored in the storage unit 102 using total internal reflection.

The reflector unit 104 is operatively connected to the storage unit 103 for reflecting the stored energy released from the storage unit 103. The reflector unit 103 is oriented towards the storage unit for receiving the energy and reflecting the energy towards a desired location. The reflector unit 103 includes a plurality of optical means for receiving of the stored energy from the storage unit and maximizing the reflecting of the received energy towards the desired location.

In an embodiment, the collector unit 102 acts as a reflector unit 104.

The structural unit 105 connects components of the system including collector unit 102, the storage unit 103 and the reflector unit 104 through structural elements for providing support.

In an embodiment, the optical means of the collector unit 102, the storage unit 103 and the reflector unit 104 include but not limited to ray, inference, diffractive, photonic, and meta optical elements. In an embodiment, length scale of the optical means includes but not limited to macro, micro and nano level. In an embodiment, material of the optical means includes but not limited to transparent material such as polycarbonate, glass, composites, alloys and metacomposites.

In an embodiment, the energy 101 is a light energy, wherein the source is a light source. In a preferred embodiment, the source is the Sun, and the energy is the solar energy in a form of light.

In an embodiment, the energy which is collected, stored, focused and reflected includes energy from the solar spectrum in the Ultra Violet region having wavelength ranging from 280 nm to 380 nm and frequency ranging from 800 THz to 30,000THz, visible light region having wavelength ranging from 380 nm to 780 nm and frequency ranging from 400 THz-800 THz, near infrared region having wavelength ranging from 780nm to 1400 nm and frequency ranging from 215 THz-300 THz, Middle infrared region having wavelength ranging from 1400 nm to 3000 nm and frequency ranging from 30 THz-120 THz and far infrared having wavelength ranging from 1000 nm to 2500 nm and frequency ranging from 300 GHz to 30 THz. Thermal radiation range of wavelength spans from 100 nm to 100,000 nm. Visible light is a very small part of the electromagnetic spectrum from solar radiation. The energy source is not limited to visible light of the electromagnetic spectrum.

FIG. 1b illustrates a front view of the system for collecting, storing and reflecting energy. The system shows the various orientation of the Sun as the source 110 relative to the collector unit 102.

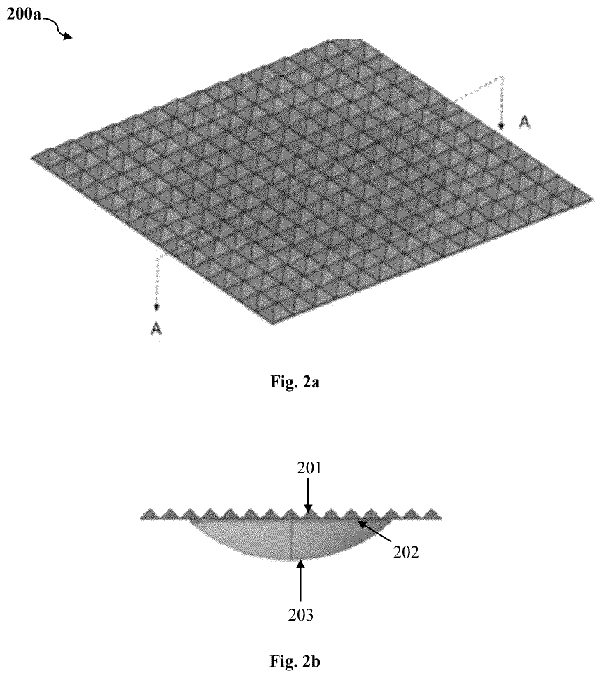

FIG. 2a illustrates an isometric view of the collector of the system. The collector unit 102 includes the plurality of optical means placed for efficiently collecting the energy from the source. The plurality of optical means is aligned for collecting the incoming energy from the source and focusing the collected energy to the desired direction.

FIG. 2b illustrates a sectional view of the collector unit of the system. The two-dimensional cross-sectional view at a section A-A of the collector unit 102 shows a first portion 201, a second portion 202 and a third portion 203. The first portion 201 is proximal to the source of the energy for maximizing collection of the energy 101. The first portion 201 is made of optical means including but not limited to one or a combination of conventional prism, Fresnel prisms, retro reflectors, moth eye optical elements, refractive optical elements, diffractive optical elements, photonic crystals and metamaterial optical elements.

The system components physical dimension range from 0.01 meters to 100 meters, more specifically from 0.05 meters to 10 meters, more specifically from 0.5 meters to 2.5 meters and the sub elements range from 0.0001 micrometers to 1000 micrometers, more specifically from 0.001 micrometers to 100 micrometers, more specifically from 0.01 micrometers to 10 micrometers, the sub-sub elements optical components range from 0.0001 nanometers to 1000 nanometers, more specifically from 0.001 nanometers to 100 nanometers.

In an embodiment, source of energy is the Sun, the light energy from the Sun is filtered wherein incoming light is converted at the first potion 201 to visible light for increasing radiation and luminescence.

The Ultraviolet (UV) light is up converted to visible light and the Infrared (IR) light is down converted to visible light using conventional means.

In an embodiment, the collector unit 102 is coated with up conversion and down conversion coating for converting incident light to visible light or any light in the electromagnetic spectrum. In another embodiment, the collector unit 102 is coated with conventional selective up conversion and down conversion additives. In another embodiment, the collector unit 102 includes conventional selective up conversion and down conversion optical means for converting incident light to a light having a desired wavelength.

The second portion 202 is provided for propagating the collected energy. The second portion 202 propagates the energy efficiently without optical attenuation. The second portion 202 supports the first portion 201 structurally. The energy propagated from the second portion is directed to the third portion 203.

The third portion 203 is provided for focusing the energy at a predetermined angle. In an embodiment, the predetermined angle is an angle below a critical angle of the storage unit 103 for creating total internal reflection. The third portion 203 is made of optical means including but not limited to one or a combination of conventional lens, Fresnel lens, conventional prism, Fresnel prisms, refractive optical elements, diffractive optical elements, photonic crystals and metamaterial optical elements. In a preferred embodiment, the third portion 203 is made of conventional lens or Fresnel lens for directing the energy at the predetermined angle.

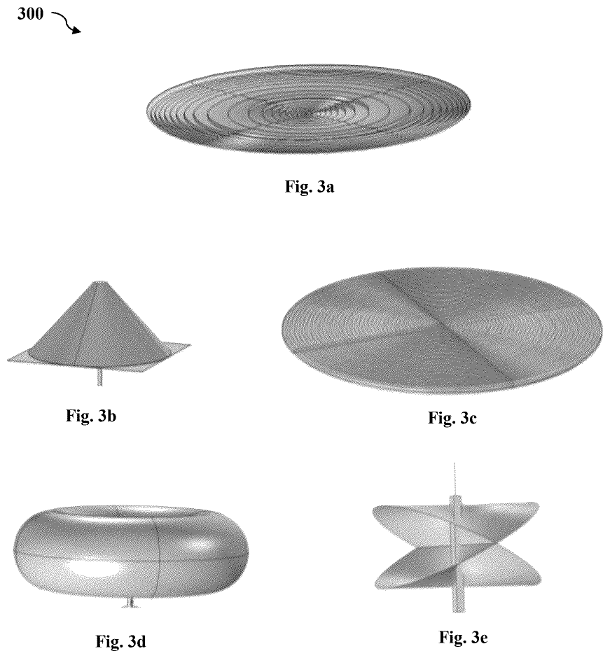

FIG. 3a, FIG. 3b, FIG. 3c, FIG. 3d and FIG. 3e illustrates an isometric view of the collector of the system, according to alternate embodiments. The collector unit 102 for maximizing collection of the energy, propagating the energy and focusing the energy at the predetermined angle are represented in the FIG. 3a, FIG. 3b, FIG. 3c, FIG. 3d and FIG. 3e.

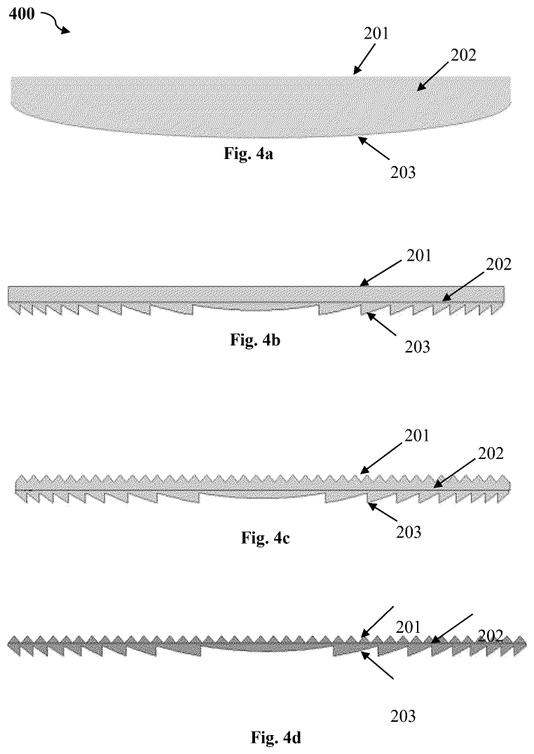

FIG. 4a, FIG. 4b, FIG. 4c and FIG. 4d illustrate a sectional view of the collector unit of the system, according to alternate embodiments. The FIG. 4a, FIG. 4b, FIG. 4c and FIG. 4d represent the first portion 201, the second portion 202 and the third portion 203 in a plurality of alignments and shapes for maximizing collection of the energy, propagating the collected energy without loss and focusing the energy at the predetermined angle.

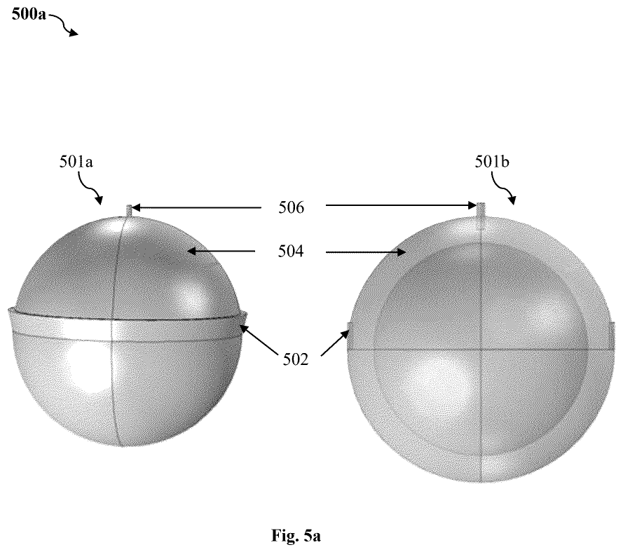

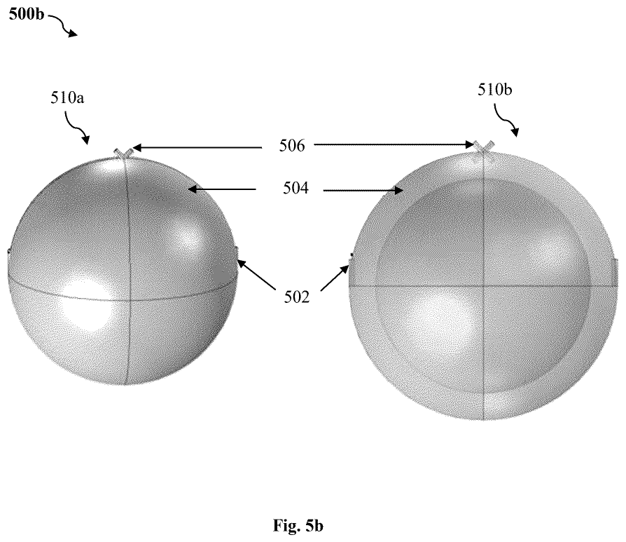

FIG. 5a illustrates a storage unit of the system, according to an embodiment. The storage unit 501a is a three-dimensional isometric view and the storage unit 501b is a sectional view of the storage unit 501a. The storage unit 501a includes an input portion 502, a storage portion 504 and an output portion 506. The input portion 504 receives the energy from the third portion 203 of the collector unit at a predetermined angle. In an embodiment, the predetermined angle is an angle below the critical angle of the storage portion 504 for creating total internal reflection. The input portion 502 couples the focused energy to the storage portion 504 at the predetermined angle for causing total internal reflection within the storage portion 504. In an embodiment, the input portion 502 is made of optical means acting as secondary focusing elements and guiding elements for focusing the energy at an angle equal to the predetermined angle of the energy received from the collector unit 102 to produce total internal reflection.

In an embodiment, the input portion 502 is a coupler provided around an external surface area of the storage unit 103. In a preferred embodiment, the input portion 102 is provided around external circumference of the storage unit 501a for efficiently receiving the energy from the collector unit 102. In an embodiment, the input portion 502 is placed within optical coupling range from the collector unit 102.

The storage portion 504 is provided for storing the energy for a desired duration of time. The storage portion 504 traps the energy through total internal reflection due to the incident angle of the energy coming from the third portion 203 of the collector unit 102. In an embodiment, the storage portion 502 traps the energy for a duration less than or equal to 12 hours with minimal to no loss. In an embodiment, the storage portion 504 includes light trapping multi layered coating and photonic band gap materials for trapping the energy. The multi layered coating includes a refractive index ranging from 1 to 2. In a preferred embodiment, the refractive index includes a range of 1.4 to 1.6, preferably 1.45 or 1.55. In an embodiment, number of layers of the coating includes a range of 2 layers to 10000 layers. In a preferred embodiment, the number of layers is 4 layers or a multiple of 4 layers. The coating is alternatively coated with the photonic band gaps.

In an embodiment, diameter of photonic band gap is in a range of 10 nanometers to 1000 nanometers and diameters of repeat unit of the photonic band gap is in a range of 20 nanometers to 5000 nanometers.

In an embodiment, the storage unit 103 is an energy efficient storage reducing energy loss. Inside surface of the storage portion 103 is coated with broad band multilayer coating, and photonic band gap for minimizing loss of the energy. Diffractive optical elements is provided for the output portion 506 for minimizing leakage loss at sub wavelength level. The energy inside the storage unit 103 is recharged by the solar energy being received by the system.

Dimensions of the storage unit including but not limited to diameter and thickness are based on the duration of storage of the energy and loss of the energy.

In an embodiment, physical dimensions of the collector unit (102), the storage unit (103) and the reflector unit (104) ranging from 0.01 meters to 100 meters, specifically from 0.05 meters to 10 meters, and more specifically from 0.5 meters to 2.5 meters. Physical dimensions of sub elements including optical means in the collector unit (102), the storage unit (103) and the reflector unit (104) ranging from 0.0001 micrometers to 1000 micrometers, specifically from 0.001 micrometers to 100 micrometers, and more specifically from 0.01 micrometers to 10 micrometers.

The output portion 506 is provided for coupling out the stored energy at the desired time for a desired duration of time. A releasing unit is connected to the output portion 506 for selectively releasing the energy from the storage portion. In an embodiment, dimensional range of the releasing unit is in nanometers. The output portion 506 is provided at an interface between the storage portion and outside the storage unit 103. The output portion 506 includes optical means for focusing, guiding and releasing the stored energy. In an embodiment, the output portion 506 is provided as an output coupler. In an embodiment, the output portion 506 is made of optical means including but not limited to one or a combination of conventional slots, Fresnel slots, refractive elements, diffractive optical elements, photonic crystals, and metamaterial optical elements. In a preferred embodiment, the optical means of the output portion 506 is a selective diffractive coupler.

In an embodiment, the output portion 506 is placed at an inverse focal length from the collector unit 102.

In an embodiment, a material of the storage unit 103 is selected from a group consisting of polymer, glass and related materials for withstanding heat generated from the energy.

FIG. 5b illustrates a storage unit of the system, according to another embodiment. The storage unit 510a is a three-dimensional isometric view and the storage unit 510b is two-dimensional sectional view of the storage unit 510a. The input portion 502 is provided externally to the storage unit 510a for receiving the energy at the predetermined angle from the third portion 203 of the collector unit 102. The energy from the input coupler is directed to the storage portion 504, wherein the energy is incident at the predetermined angle, which is within a critical angle of the storage portion, for creating total internal reflection. The storage portion 504 traps the energy for a desired duration of time less than or equal to 12 hours. The trapped energy is directed to the output portion 506 for releasing the energy at the desired time for a desired duration. In an embodiment, the output portion 506 is provided as an X-shaped output coupler.

In an embodiment, a shape of the storage unit 103 is selected from a group consisting of sphere, hollow sphere, cylinder, prism and any shape suitable for storing.

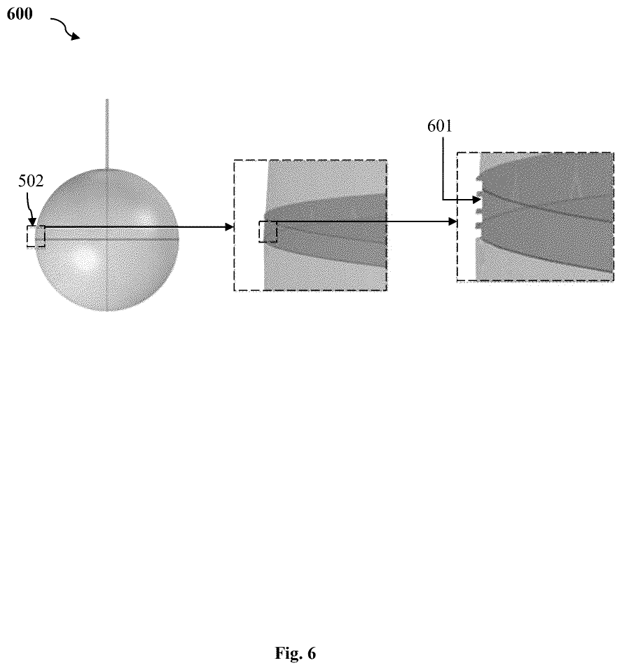

FIG. 6 illustrates an input portion of the storage unit of the system. In an embodiment, the input portion 502 of the storage unit 103 includes optical means for allowing focused energy from the third portion of the collector unit 102 at the predetermined angle. In an embodiment, the input portion 502 includes optical couplers for efficiently allowing the energy.

FIG. 7 illustrates an output portion of the storage unit of the system. In an embodiment, the output portion 506 of the storage unit 103 includes optical means 701 for releasing stored energy from the storage portion 504 of the storage unit 103. In an embodiment, the output portion 506 includes optical couplers for efficiently releasing the energy at a desired time for a desired duration to the reflector unit 104.

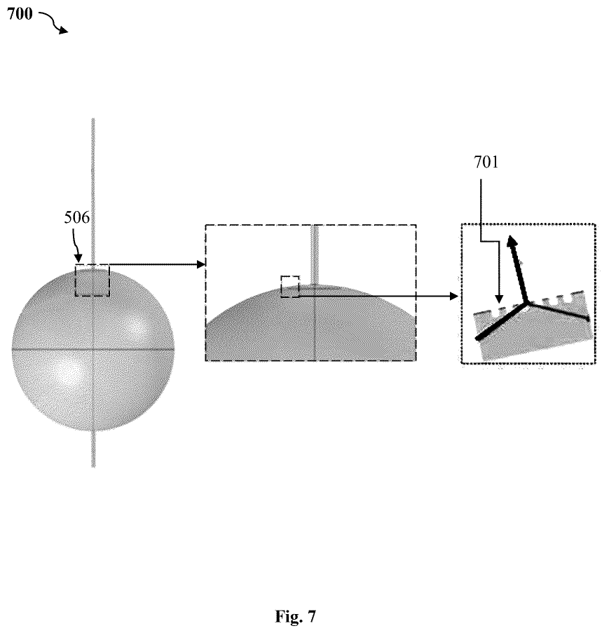

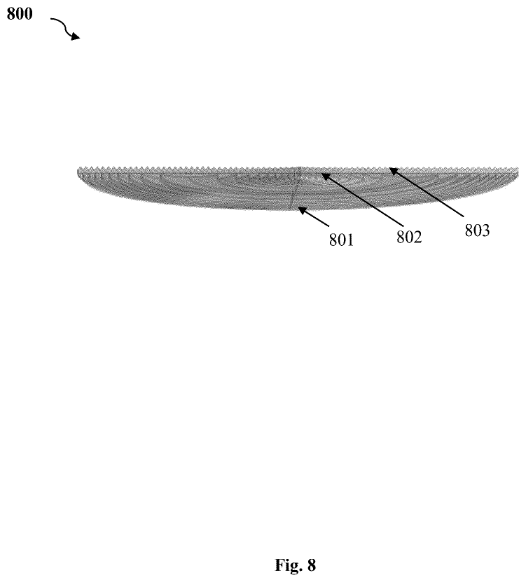

FIG. 8 illustrates a reflector unit of the system. In an embodiment, the reflector unit 104 includes a first portion 801, a second portion 802 and a third portion 803. The first portion 801 is provided for receiving the energy from the output portion of the storage unit 103, the second portion 802 propagates the energy and the third portion 803 reflects the energy for illumination of an area below the reflector unit 104. In an embodiment, the first portion 801, the second portion, 802 and the third portion 803 are made of optical means for receiving and reflecting the energy from the storage unit 103 with minimal loss.

In an embodiment, the collector unit 102 acts as the reflector unit 104 from a side proximal to the storage unit 103. Outer surface of the third portion 203 acts as a first portion 801 of the reflector 104 for allowing energy from the storage unit. The second portion 202 acts as a second portion 802 of the reflector for propagating the energy. An inside surface of the third portion 203 acts as the third portion 803 for reflecting energy towards the desired area for illumination

FIG. 9 illustrates a structural unit of the system, according to an embodiment.

The structural unit 105 is provided for connecting and supporting the collector unit 102, the storage unit 103 and the reflector unit 104. The structural unit 105 includes a foundation 901 and structural members 902. The foundation 901 a base for imparting stability to the components of the system. Connection members (not shown in figure) are provided connecting the collector unit 102, the storage unit 103 and the reflector unit 104 to the structural members 902. In an embodiment, the structural members include but not limited to column, beam, truss, plates, strings and any element providing support to components of the system. The structural unit 105 provides structural stability to the components of the system and ensure minimal optical disturbance to the components while collection of energy, storing the energy and reflection of the energy. In an embodiment, material of the structural unit 105 includes but not limited to metal, alloy, ceramic, polymer and composites.

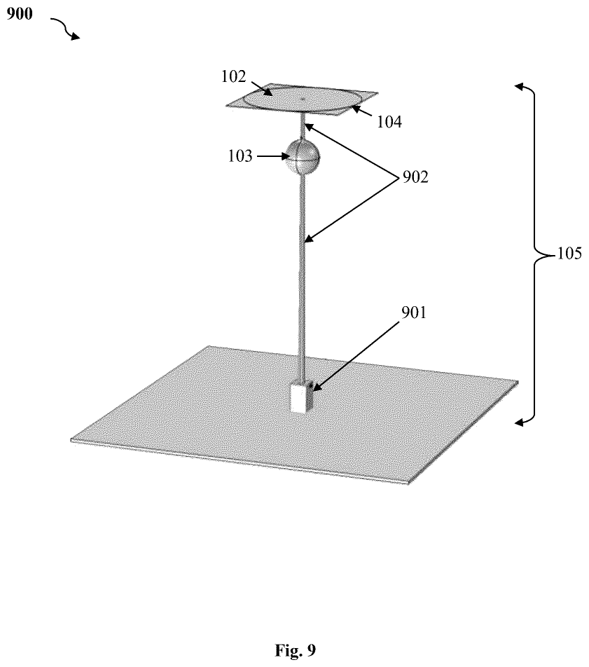

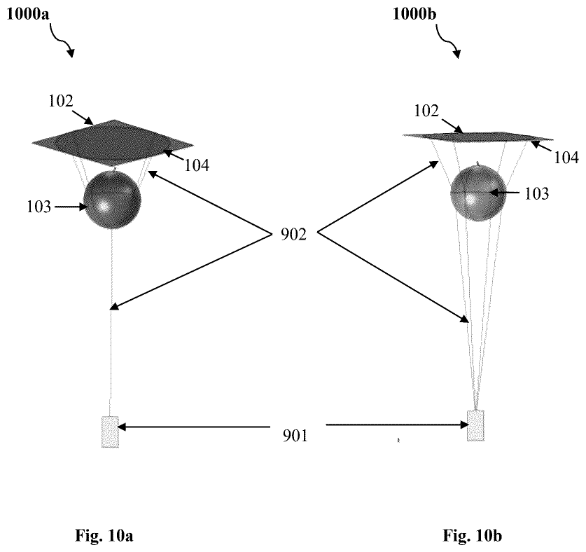

FIG. 10a and FIG. 10b illustrates structural unit of the system, according to alternate embodiments. The foundation 901 is provided as the base and the structural members support the storage unit 103 from the foundation 901. Structural members 902 are provided between the collector unit 102, reflector unit 104 and the storage unit 103.

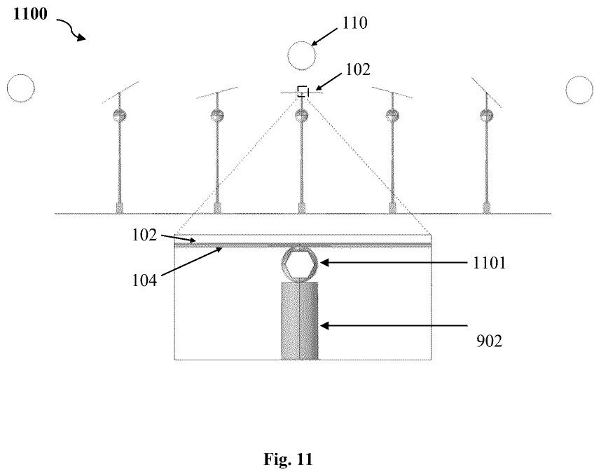

FIG. 11 illustrates a tracking mechanism of the collector unit of the system. The collector unit 102 maximizes the collection of the energy from the source 110 wherein the first portion 201 is oriented proximal to the source 110. In an embodiment, the source 110 is the Sun, and the Sun has different position at different times of the day. The tracking mechanism 1101 is connected to the collector unit 102 for changing orientation of the collector unit 102 based on the position of the Sun. In an embodiment, the tracking mechanism 1101 includes conventional sensors for detecting position of the Sun, and based on the position, the tracking mechanism 1101 tilts the collector unit 102 for maximizing the collection of energy. The tracking mechanism is connected between the structural member 902 and the third portion 203 of the collector unit 103. In an embodiment wherein the collector unit 102 is the reflector unit, the tracking mechanism 1101 is connected between the structural member 902 and the first portion of the reflector unit 104.

In an embodiment, the tracking mechanism 101 includes but not limited to heliostats and solar tracking mechanism.

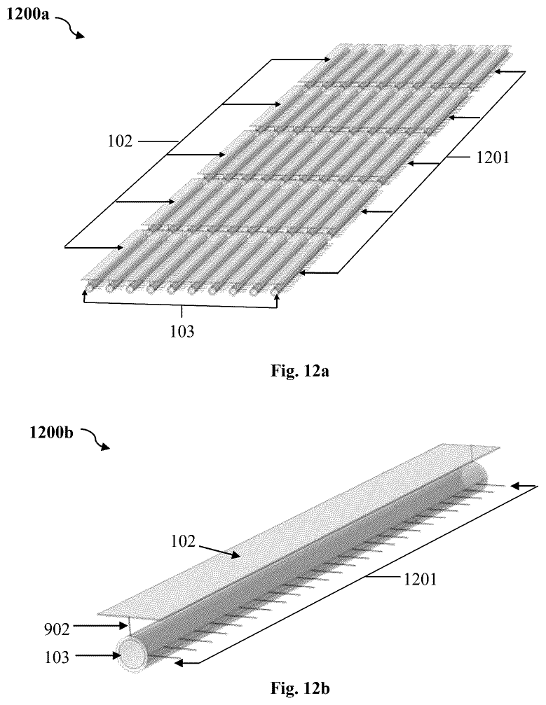

FIG. 12a illustrates a system providing large scale collection of energy, storage and distribution of the energy. In an embodiment, a plurality of collector units 102 is provided in multiple arrays for large scale collection of the energy from the source. Each array of the collector unit 102 is operatively connected to a plurality of storage units 103 for storing the large amount of energy collected. Each storage unit includes a distribution system 1201 for distributing the stored energy to a desired location. In an embodiment, the distribution system 1201 includes a plurality of the output portion 506 for releasing the energy and efficiently distributing the stored energy.

FIG. 12b illustrates a single unit of the system 1200a providing large scale collection of energy, storage and distribution of the energy. A single unit 1200b of the system includes the collector unit 102 having a large surface area for collecting the energy from the source. The collector unit 102 is connected to the storage unit 103 through the structural member 902. The input portion 502 (not shown in figure) is provided inside the structural member 902 for transmitting the energy to the reflector unit 104. In an embodiment, shape of the storage unit 103 is hollow cylindrical. The distribution system 1201 is connected to the storage unit 103 for distributing the large amount of stored energy at a desired time to a desired location.

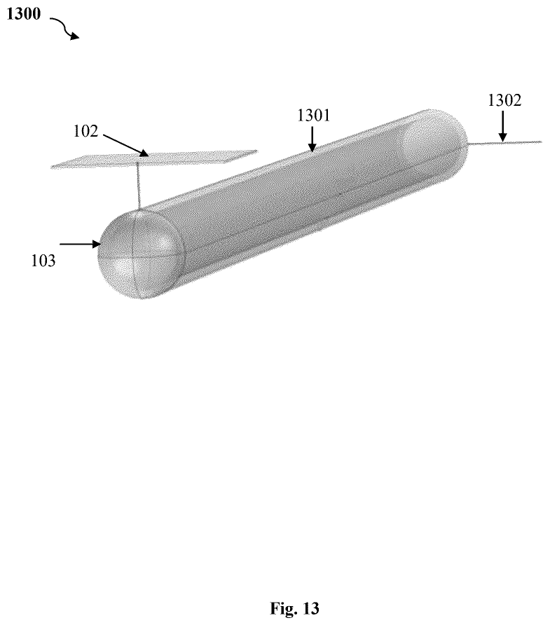

FIG. 13 illustrates a system providing collection, long term storage of energy, and distribution of the energy. The system 1300 includes the collector unit 102 collecting energy from the source. The energy collected from the collector unit is transmitted to the storage unit 103 at the predetermined angle. An extended storage unit 1301 is connected to the storage unit 103 for storing the energy. The extended storage unit 1301 increases the storage capacity of the storage unit 103 for the given collector unit 102, thereby providing long term storage of the energy. In an embodiment, the extended storage unit 1301 includes time selective output couplers for extended release of the stored energy.

A distribution system 1302 is connected to the storage unit system 103, 1301 for distributing the energy at a desired time. In an embodiment, the energy from the storage unit 103 is transferred to the extended storage unit 1301 at a predetermined angle, wherein the predetermined angle is an angle below the critical angle of the extended storage unit 1301 for creating total internal reflection.

In an embodiment, optical means for the distribution system 1302 includes but not limited to light channels, fiber optic means, and energy transport channels.

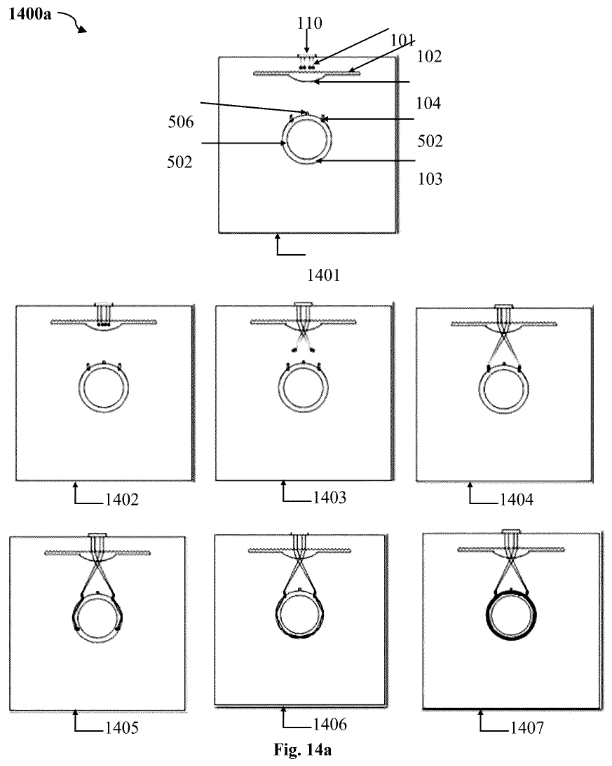

FIG. 14a and FIG. 14b illustrate a working of the system for collecting, storing and releasing energy.

Block 1401 shows the components of the system, wherein the components include the collector unit 102, the storage unit 103, the reflector unit 104, the source 110, the energy 101, the input portion 502, the storage portion 504 and the output portion 506. Block 1401 shows the source 110 releasing the energy 101. Block 1402 shows the collector unit 102 collecting the energy and propagating the energy. Block 1403 depicts the collector unit 102 focusing the energy at the predetermined angle, wherein the predetermined angle is an angle below the critical angle of the storage unit 103. Block 1404 displays the focused energy reaching the storage unit 103 at the input portion 502. Block 1405 shows the energy focused inside the storage portion 504 at the predetermined angle, thereby creating total internal reflection. Block 1406 and block 1407 disclose the storage of energy inside the storage portion 504 of the storage unit 103. At block 1408, the energy is stored inside the storage portion 504 for a desired duration of time. Next, at block 1409, releasing unit of the output portion is opened for releasing the stored energy. At block 1410, the energy is released from the output portion 506 and at block 1411 the released energy strikes the reflector unit 104. At block 1412, block 1413 and block 1414, amount of energy reflected from the reflector unit 104 is increasing. At block 1415, the reflected energy reaches the desired location 106 for illumination.

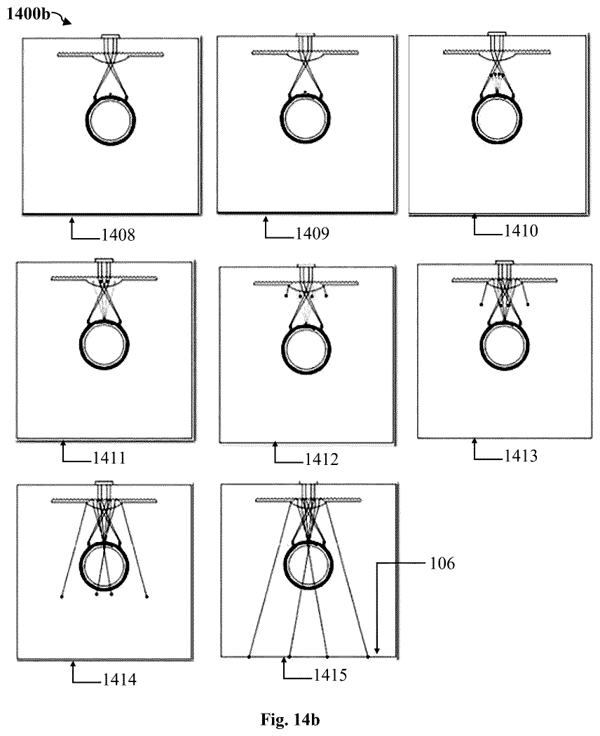

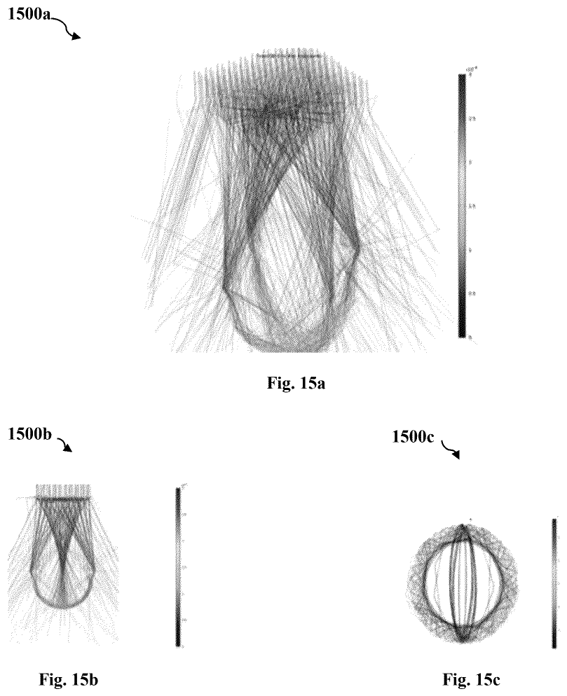

FIG. 15a illustrates a three-dimensional view of ray tracing or wave propagation of energy of the system. 1500a shows the ray tracing of the energy from the source released onto the collector unit, stored in the storage unit, released to the reflector unit and reflected from the reflector unit

FIG. 15b illustrates a two-dimensional front view of ray tracing of energy of the system. 1500b represents the energy through ray tracing released from the source, collected by the collector unit, stored in the storage unit, released to the reflector unit and reflected from the reflector unit for illumination.

FIG. 15c illustrates a two-dimensional view of ray tracing of energy inside the storage unit. 1500c represents the energy stored inside the storage unit through total internal reflection.

A main advantage of the present disclosure is that the system provides storage of energy for a desired duration of time.

Another advantage of the present disclosure is that the system provides a cost-effective system for collecting energy, storing energy and releasing energy.

Still another advantage of the present disclosure is that the system provides an efficient system for collecting, storing and releasing energy with minimal loss.

Yet another advantage of the present disclosure is that the system provides long term storage of energy.

Another advantage of the present disclosure is that the system provides storage of energy for a desired duration of time.

Still another advantage of the present disclosure is that the system provides

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A system for storing energy, comprising:
a collector unit (102) provided for collecting energy (101) from a source (110) using optical means;
characterized in that
a storage unit (103) operatively connected to the collector unit (102) for storing the collected energy using optical means; and
a reflector unit (104) operatively connected to the storage unit (103) for reflecting the energy released from the storage unit (103) using optical means.

2. The system as claimed in claim 1, wherein the collector unit (102) includes a first portion (201), a second portion (202) and a third portion (203);
the first portion (201) provided for maximizing collection of the energy;
the second portion (202) provided for propagating the collected energy; and
the third portion (203) provided for focusing the energy at a predetermined angle.

3. The system as claimed in claim 2, wherein the first portion, the second portion and the third portion constitute optical means selected from a group consisting of conventional prism, Fresnel prisms, retro reflectors, moth eye optical elements, refractive optical elements, diffractive optical elements, photonic crystals and metamaterial optical elements for maximizing performance.

4. The system as claimed in claim 2, wherein the storage unit (103) includes an input portion (501), a storage portion (502) and an output portion (503);
the input portion (501) receiving the focused energy from the third portion (203) of the collector unit (102) at the predetermined angle for directing the focused energy;
the storage portion (103) receiving the energy from the input portion (501) and storing the energy through total internal reflection; and
the output portion (503) releasing the stored energy to the reflector unit (104).

5. The system as claimed in claim 1, wherein the reflector unit (104) includes a first portion (801), a second portion (802) and a third portion (803);
the first portion (801) provided proximal to the storage unit (103) for receiving the stored energy;
the second portion (802) provided for propagating the received energy; and
the third portion (803) provided distal to the storage unit (103) for reflecting the energy.

6. The system as claimed in claim 4, wherein the output portion (503) of the storage unit (103) includes a releasing unit for releasing the stored energy at a desired time and for a desired duration.

7. The system as claimed in claim 6, wherein the releasing unit including optical means selected from a group consisting of conventional slots, Fresnel slots, refractive optical elements, diffractive optical elements, photonic crystals and metamaterial optical elements.

8. The system as claimed in claim 1, wherein the energy (101) is solar energy and the source (110) is Sun.

9. The system as claimed in claim 1, wherein the first portion (201) of the collector unit (102) converts incident light from the solar energy to visible light.

10. The system as claimed in claim 2, wherein the predetermined angle is an acceptance angle of the storage portion (504) for low loss storage.

11. The system as claimed in claim 1, wherein a shape of the storage unit (103) is selected from a group consisting of sphere, hollow sphere, cylinder, prism and fiber for storing.

12. The system as claimed in claim 1, wherein the collector unit (102) acts as the reflector unit (104) for reflecting the energy.

13. The system as claimed in claim 1, wherein the collector unit (102) collects energy during availability of the Sun, the storage unit (103) stores the energy and releases the energy to the reflector unit (104) for reflecting the energy during non-availability of the Sun.

14. An apparatus for interacting with energy, comprising:
a collector unit (102) for collecting the energy,
a storage unit (103) for receiving the collected energy and storing the received energy;
a releasing unit for releasing the stored energy; and
a reflector unit (104) for reflecting the released energy.

15. The apparatus as claimed in claim 14, wherein the energy is selected from a group consisting of electromagnetic energy, solar energy, optical energy and visible light energy.

16. The apparatus as claimed in claim 14, the wherein the energy is visible light energy operating using direct optical means and releasing optical energy for illumination.

17. The apparatus as claimed in claim 14, wherein the collector unit (102) performs as the reflector unit (104) for illumination.

18. The apparatus as claimed in claim 14, wherein the collector unit (102), storage unit (103), the releasing unit and the reflector unit (104) are operationally coupled by optical and structural means.

19. The apparatus as claimed in claim 14, wherein operational time is a 24 hours day cycle including collection and storage operational time of 12 hours and releasing operational time between 2 hours to 12 hours.

20. The apparatus as claimed in claim 14, wherein operational time is an annual cycle including collection and storage operational time greater than 12 hours and releasing operational time greater than a range of 2 hours to 12 hours.

21. The apparatus as claimed in claim 14, wherein elements of the collector unit (102), the storage unit (103), the releasing unit and the reflector unit (104) are selected from a group consisting of ray, refractive, interference, diffractive, photonic, and meta optical elements for maximizing performance.
